(19) United States
(12) Patent Application Publication
(10) Pub. No.: US 2023/0267382 A1
(43) Pub. Date: Aug. 24, 2023

(54) SYSTEM AND METHOD FOR MONETIZING SPACES AND FACILITATING COLLABORATION

(71) Applicant: Kennedy Uzomba, Acworth, GA (US)

(72) Inventor: Kennedy Uzomba, Acworth, GA (US)

(21) Appl. No.: 17/864,992

(22) Filed: Jul. 14, 2022

Related U.S. Application Data
(60) Provisional application No. 63/312,002, filed on Feb. 19, 2022.

(51) Int. Cl. G06Q 10/02; G06Q 30/06

(52) U.S. Cl. CPC G06Q 10/02; G06Q 30/0645; G06Q 30/0641

(57) ABSTRACT

A system and method for monetizing a utility space, such as a utility space in a home, garden, lawn, building, office, warehouse, industrial premises, school and college buildings, auditoriums, resorts, laboratories, studios, film sets, restaurants, and the like. The method includes the steps of providing an interface for the space provider and the service provider to list their utility space and a service, respectively. The service and the utility space can be linked. Moreover, the method provides collaboration with third-party services, such as CRM services.

### CROSS-REFERENCE TO RELATED APPLICATIONS

This application claims priority from a U.S. Provisional Patent Appl. No. 63/312,002 filed on Feb. 19, 2022, which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the U.S. Patent and Trademark Office files or records, but otherwise reserves all copyright and trade dress rights whatsoever.

### FIELD OF INVENTION

The present invention relates to a system and method for booking rental spaces, and more particularly, the present invention relates to a system and method for renting spaces for different purposes and services.

### BACKGROUND

Platforms for booking lodging, hotels, resorts, and like are well known in the art. Users, including travelers, businessmen, and the like can use such platforms to explore different places, check availability at desired dates, and book the desired place in advance. Such platforms are quite useful for the travelers and like people.

Besides lodging, many people often may have utility spaces that may remain vacant from time to time and or un-utilized or even under-utilized. Examples of such utility space may include office space, a residence room, warehouse, studio; rooms and lab spaces in schools, studios, meeting rooms, event locations, and the like. There are very few options available for monetizing such unused utility spaces. Moreover, known methods are available only for a very limited type of space, such as long-term leasing of office space, short term hotel rooms. However, we have found that a host may have a utility space that remains vacant for only a few hours in a day. Known methods can provide for monetizing such utility spaces that are available only for few hours in a day. Also, it is appreciated that a maximum benefit can be made from such a utility.

The user may also need a host of services, such as online marketing and local market capture and consumers. The user encounters a lot of issues while booking such services. Lack of proper resources result in the loss of sales and ease when purchasing services and space. Some of the major limitations and drawbacks include: PRICE—important for users booking accommodations and services online; LOCAL MARKETING—all businesses are sometimes disjointed from their local marketplace; INCONVENIENCE—hotels leave you disjointed from the city; VENUES—hotel web portals are often complicated to use; MARKETING DILEMMA—disjointed access to local markets—disjointed accommodation and services marketplace; BUSINESS CONTINUITY—disjointed access to service providers and local host that provides services; NETWORKING—disjointed access for facilitators to network with startups & execute ideas—disjointed access to distribution channels that scale ideas; CONTRACTOR RELATIONS—disjointed contractor relations dynamics—disjointed scope of work documentation and change order control; GROUP DYNAMICS—disjointed group coordination dynamics—disjointed group ePayment systems.

A need is therefore appreciated for a platform that fulfills previously mentioned deficiencies in the known booking platforms. A need is there for a platform that allows booking quality spaces, services, ride share and delivery experiences all at one place.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that allow monetization of utility spaces, and related services thereof.

It is another object of the present invention that the user may readily acquire related services.

It is still another object of the present invention that the user can easily collaborate with others.

It is a further object of the present invention that productivity is increased.

It is yet another object of the present invention that the cost of operations can be reduced in businesses and professions.

In one aspect, disclosed is a method for monetizing utility spaces, the method implemented with a system comprising a processor and a memory, the system configured to implement a method comprising providing an interface for a service provider, a space provider, and a user respectively; receiving, through the interface, from the space provider and the service provider, a listing of utility space and a listing of service respectively; and receiving a link between the service and the utility space. The method further comprises generating a space provider profile and a service provider profile, wherein the space provider profile comprises name and contact detail of the space provider, wherein the service provider profile comprises name and contact detail of the service provider. The listing of utility space comprises details of availability of the utility space in hours for one or more days in a week. The method further comprises displaying a list of services for a booked utility space through the interface, wherein the booked utility space is booked by the user, wherein the list of services is linked to the booked utility space. The method further comprises displaying a list of utility spaces for a booked service through the interface, wherein the user booked the booked service, wherein the list of utility spaces are linked to the booked service. The method further comprises linking a plurality of third-party services to the service and the utility space, wherein the plurality of third-party services comprises customer relationship management services. The utility space is present in a home, garden, lawn, building, office, warehouse, industrial premises, school and college buildings, auditoriums, resorts, laboratories, studios, film sets, or restaurants. The method further comprises providing a first listing template to the service provider, a second listing template to the space provider, wherein each of the first listing template and the second listing template are configured to receive information in a structured manner, wherein each of the first listing template and the second listing template are divided into a plurality of sections, the plurality of sections linked to a menu bar. The second listing template comprises sections for description, location, amenities, photos, pricing, booking, and calendar.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an environmental of the system, according to an exemplary embodiment of the present invention.

FIG. 2 is a block diagram showing an architecture of the system, according to an exemplary embodiment of the present invention.

FIG. 3 is a block diagram showing collaboration of the disclosed system with CRM services, according to an exemplary embodiment of the present invention.

FIG. 4 is a flow chart illustrating an exemplary embodiment of the disclosed system and method, according to an exemplary present invention.

FIG. 5 is a main menu bar showing options to navigate through an interface of the disclosed system, according to an exemplary embodiment of the present invention.

FIG. 6 is a navigation menu for different sections of a listing template, according to an exemplary embodiment of the present invention.

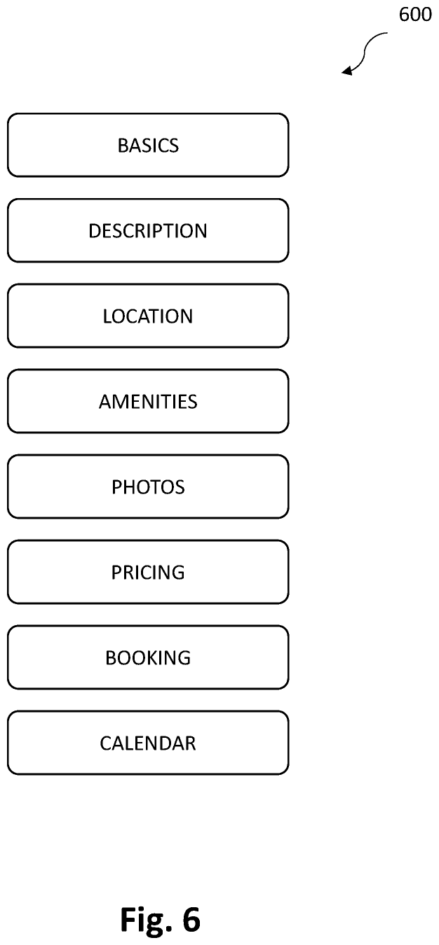

FIG. 7 is a main menu bar showing options to list a space or service, according to an exemplary embodiment of the present invention.

FIG. 8 is a screen for receiving details of availability of a space and rate card, according to an exemplary embodiment of the present invention.

FIG. 9 shows a booking screen of an interface, according to an exemplary embodiment of the present invention.

FIG. 10 is a block diagram illustrating features & benefits of the disclosed system and method, according to an exemplary embodiment of the present invention.

FIG. 11 is a flowchart illustrating the booking module, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a system and method that allows for monetizing of spaces, such as unused spaces in a building. The spaces can be any utility space in a home, garden, lawn, building, office, warehouse, industrial premises, school and college buildings, auditoriums, resorts, laboratories, studios, film sets, restaurants, and the like. The space can be for offices, fashion design houses, product development, employment services, culinary activities, fitness, studios, real estate and construction services, marketing, networking, parties, photo shoots, workshops, events, pop ups, weddings, audio recordings, film/video production, performances, retreat, home shows, meetups, classes, and the like.

The disclosed system and method allow space providers and service providers to list their spaces and services respectively. The services can be professional services and unprofessional services. The disclosed system and method may allow collaboration between the service providers, space providers, and users. The term “user” herein refers to any person or group of people using or wish to use the above services and/or spaces. The “space providers” and “service providers” are collectively referred to herein as “providers”. The disclosed system makes the listed spaces and services accessible to the users, wherein the space providers, service providers, and the users can collaborate for increased productivity, efficiency, and cost reduction. The user can navigate and/or search for desired spaces and/or services using a variety of options and parameters. The disclosed system can be particularly advantageous by allowing linking the services and spaces thereby making the process more productive, cost effective, and efficient. The operational costs of a project can be reduced significantly using the disclosed system while increasing productivity and efficiency. The collaborations between the service providers, space providers, and users allow better utilization of resources, improved monetization of spaces and services which otherwise may remain unused or under-utilized.

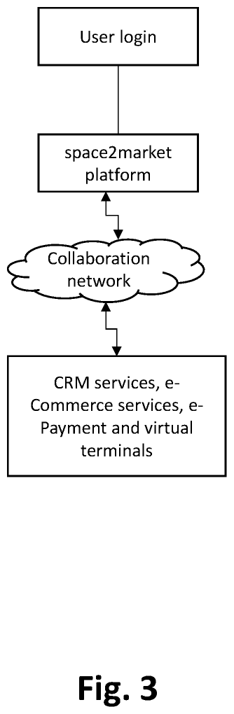

Disclosed is an all-in-one “single-entry” field management, accounting and networking platform that is designed to improve operational efficiency, reduce downtime, improve supply chain management, and deliver high quality ROI results by engaging cloud networking capabilities between users to streamline financial transactions, accounting, supply chain management, asset management, and project management via the disclosed booking system. The disclosed system can optimize peer sharing opportunities by providing high quality CRM project management software and e-Commerce solutions via e-Payment and virtual terminals to help consumers and businesses connect, monetize peer sharing opportunities, market—advertise and grow their business. The disclosed platform can assist businesses and consumers to do business in a peer-to-peer rental space, peer-to-peer business support services marketplace; and combine subscription-based managed marketing services and CRM/Project Management capabilities to book space for social activities, events, meetings, productions, and professional business services. Through disclosed data operations, managed services, and agency functions, organizations can grow by optimizing animated global map pin business locator systems to intuitively identify, compute, and store database search functionalities, and SWS service offerings for consumers, start-ups, enterprises, government agencies, and academic institutions. FIG. 3 shows the disclosed platform which is also referred to herein as space2market platform that can collaborate with third-party services or additional CRM and like services provided by the system.

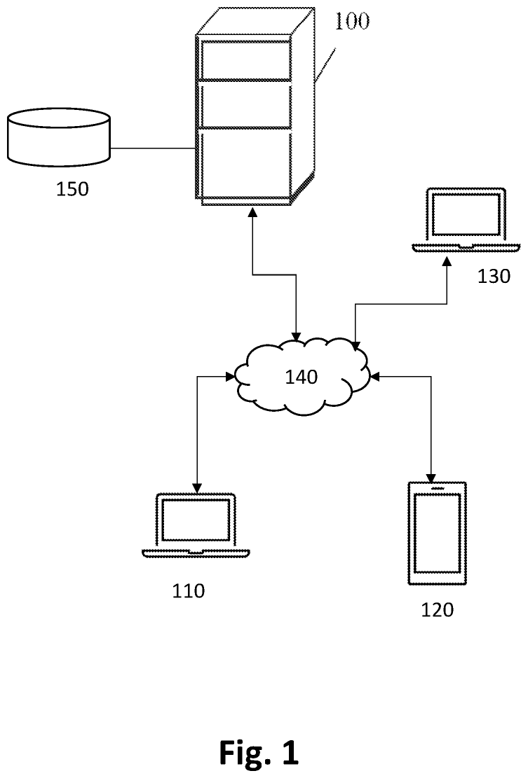

Referring to FIG. 1 which is an environmental diagram of the disclosed system 100. The system 100 can be connected to a service provider device 110, a space provider device 120, and a user device 130 through a network 140. The device can be any computer device, such as a laptop, desktop computer, tablet computer, client device, and the like. FIG. 1 shows three devices connected to the disclosed system; however, it is understood that multiple devices can simultaneously connect with the disclosed system. Also, FIG. 1 shows a single network 140 connecting the devices to the system for illustration purposes only, however, it is obvious to a reader of the application that different devices can connect using different networks, and a single device can connect through more than one network, such as a combination of wired and wireless networks. The disclosed system can also connect with a database 150 for storing the data.

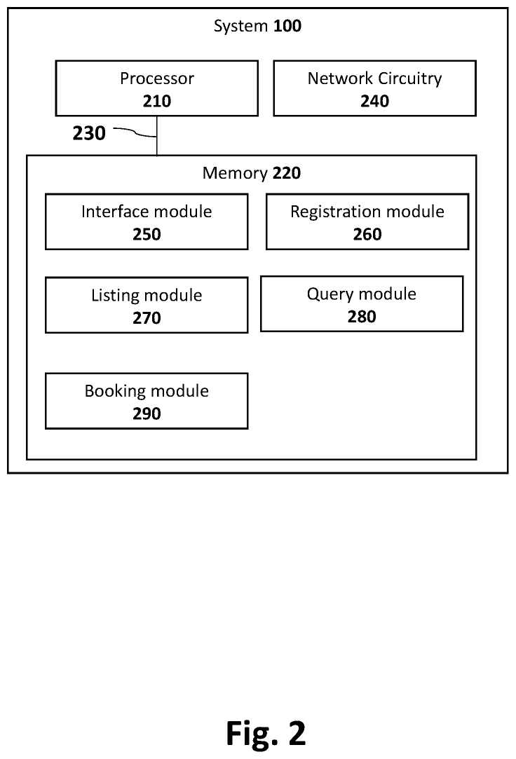

Referring to FIG. 2 which is another block diagram illustrating an architecture of the disclosed system 100. The system can include a processor 210 and a memory 220. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The system may also include a network circuitry 230 that allows the system 100 to connect to external networks, such as the network 140 shown in FIG. 1. The network may be a wired network, a wireless network, or may include a combination of wired and wireless networks. For example, the communication network may be a local area network (LAN), a wide area network (WAN), a wireless WAN, a wireless LAN (WLAN), a metropolitan area network (MAN), a wireless MAN network, a cellular data network, a cellular voice network, the Internet, etc. The disclosed system can be implemented in an environment of one or more servers which include cloud servers. More than one server can be at one location or geographically dispersed in multiple locations without departing from the scope of the present invention.

The memory can include an interface module 250, a registration module 260, a listing module 270, a query module 280, and a booking module 290. The interface module upon execution by the processor can provide one or more interfaces for interacting with the disclosed system. The registration module upon execution by the processor can allow registration of a service provider, space provider, and a user. The listing module upon execution by the processor can provide for creating, updating, and managing the listings of spaces and services. The query module upon execution by the processor can provide for creating, updating, and managing the database. The booking module upon execution by the processor can allow users to search, select, and book desired services and spaces.

The interface module upon execution by the processor can provide a suitable interface on devices of the user, service provider, and space provider to allow them to interact with the disclosed system. The interface can be provided as application software that can be installed on the device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interacting with a user and provider through the user device and provider device respectively, wherein information can be presented within the interface by the system 100 and information can be received by the system 100 from the user and provider.

The registration module upon execution by the processor can provide for registration of the users, service providers, and space providers through one or more screens of the interface. The registration module can provide credentials, such as a username and password for secure access to the disclosed system and modules thereof. Biometric mode of authentication is also within the scope of the present invention. A screen can be provided by the interface module that allows a user to enter their credentials. The registration module can receive basic details such as name, address, and contact number, and generate a profile using the same. The registration module can also provide for verification of information received, such as verification of contact number, address, email address, certification, licenses, and the like. The verification may differ for the service provider, space providers, and the users. The verification procedure may also take care of any statutory compliances that the service provider, space providers, and the users may require to comply with.

Once registered, the service provider and space providers can list their services and spaces respectively, the listing module allows the service provider and space providers to list their products by receiving related details in a structured manner. The listing module can include predefined templates to receive the structured details. The templates can be categorized using dynamic menus, wherein the provider can navigate through the menu to get the desired template that best matches to the listing. The template can include a set of questions drafted to get better details of the listing in the structured manner. For example, the space provider wishes to list a café can provide information about the space, duration, amenities available at the space, and the like.

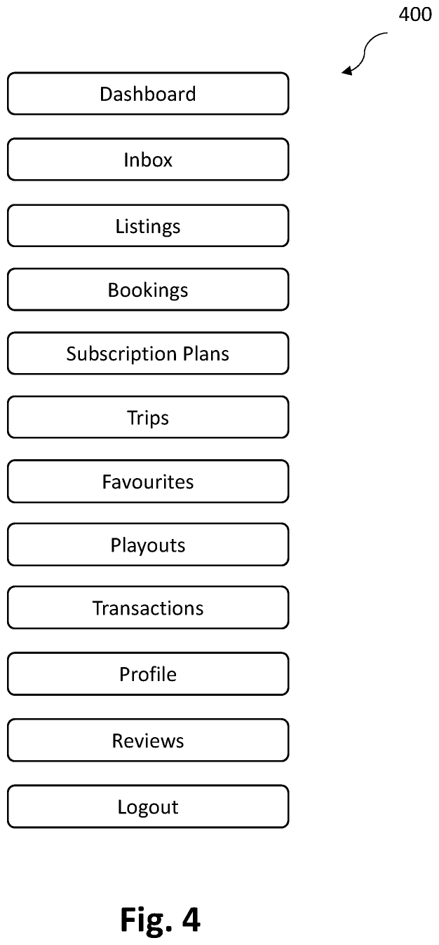

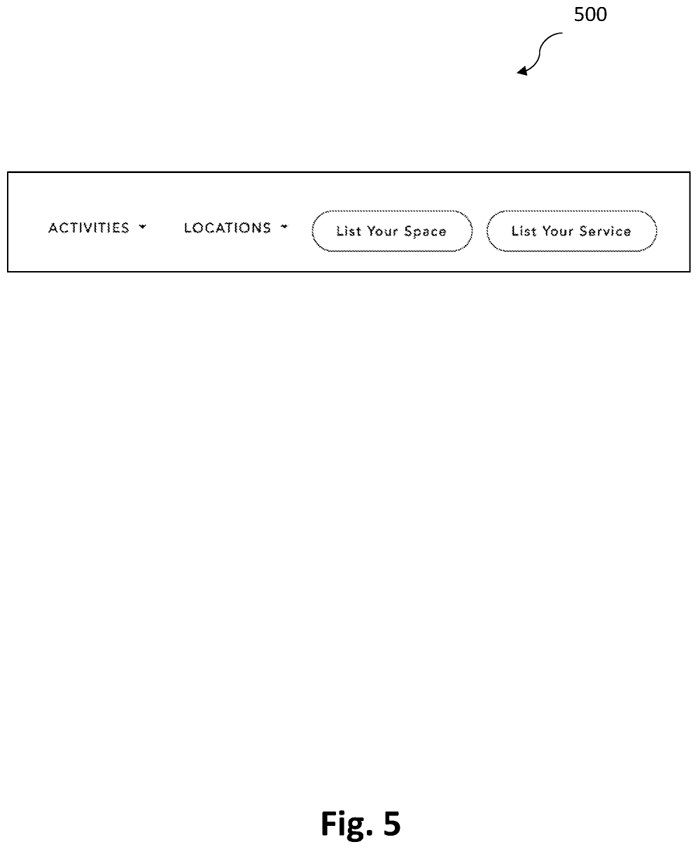

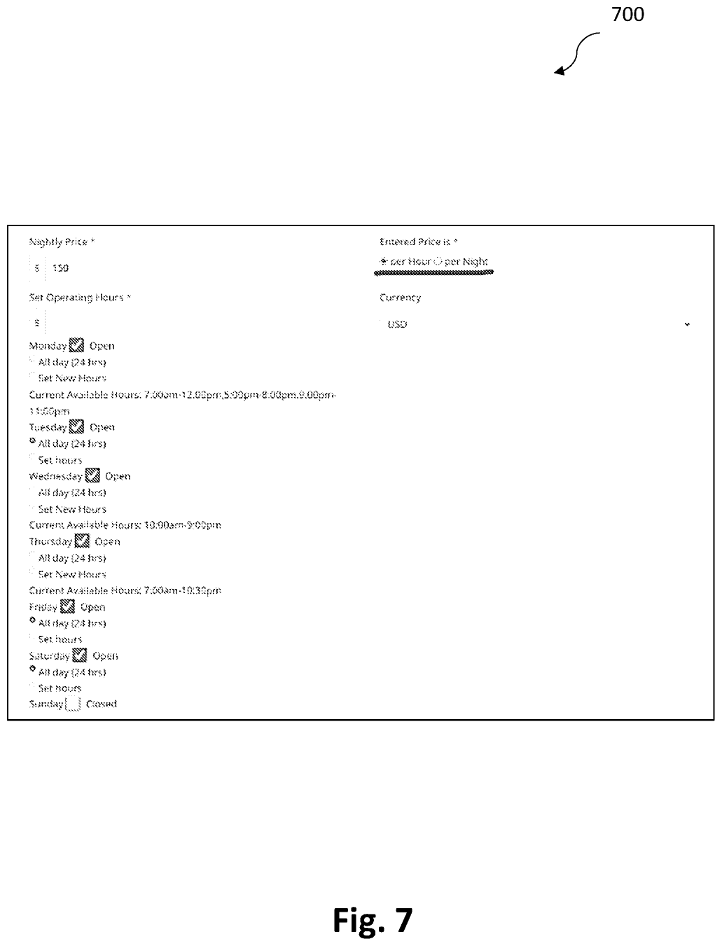

Referring to FIG. 4 shows a main menu bar of the interface provided by the interface module through which a user can navigate and open different pages of the interface for accessing different functionalities. The listing tab in the menu bar can open a second menu as shown in FIG. 5. The user can be provided with a second menu bar 500 using which the user can choose whether to list a space or service. Once the user selects between space and service, a listing template screen can be displayed through the interface. The template can in a structured format receive details about the listing from the user. Forms can be presented to the user to receive the information. The template can be divided into sections and user can jump between the sections using the menu 600 shown in FIG. 1. The user can enter basics details, description, location, amenities, photos, pricing, booking, and calendar. The user can be provided with a form 700 as shown in FIG. 7 to enter details for the timings, such as weather the space is available for full day or few hours in a day. The user can set hours during which the space or service can be utilized or booked.

The query module can store the listings in a structured and quarriable database. The query module can link the listings of the service providers and the space providers. For example, for a given space, the query module can determine the service providers that provide their services at the space. For example, the service providers can provide a range in terms of distance from their home in which services could be provided, the query module can check if the given space is within the defined radius of range, and accordingly link the service provider to the space.

For example, a group of students looking for a musical classes may be looking for a utility space and a tutor (service). The students can look for either the or the utility space. Upon selecting the desired tutor, the linked utility spaces can be populated to the user. The linked services and utility spaces can be organized in various categories, and the user can navigate through the various categories. Similarly, if the user selects a desired utility space, the associated services i.e., tutors can be presented to the user as a category.

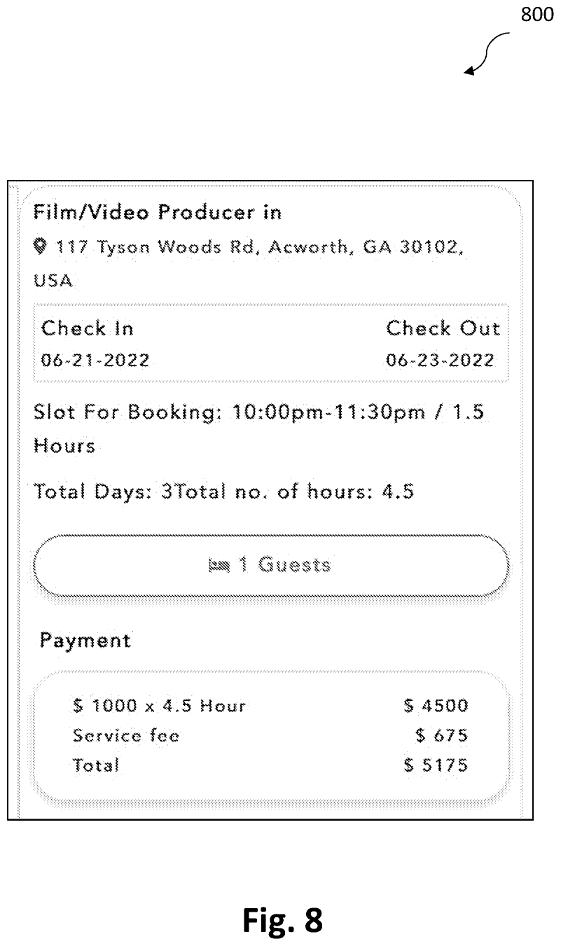

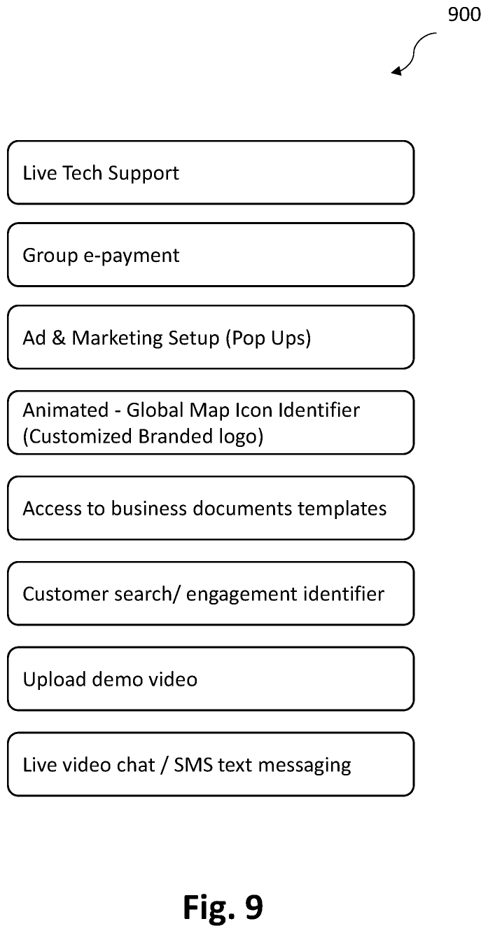

Again, referring to FIG. 5 which shows a menu of the interface which can receiving details of a listing from a space provider. On the top right corner are shown two soft buttons, one is the “list you space” and another is “list your service”. The provider can click the desired button and the associated template can be presented. On the left side of the screen is a navigation menu 400 that includes link to different pages, such as inbox, all listings, bookings. Trips, favorites, payouts, transactions, profile, reviews, and a logout button. The template can be divided into several sections and each section can have a descriptive heading, and a navigation menu can be generated that is linked to the section heading. The template menu 600 can allow navigating through the template easily using the menu bar. The sections can include description, location, amenities, photos, pricing, booking, and calendar. In the description section, the description of the space can be provided. In location section, the geographical location of the space can be provided. Such location can include geographical coordinates that can be implemented in a map, such as google maps to the show the location on the map. Details of nearby landmarks can also be handed here. In the amenities section, the list of amenities can be provided as a list form which the user can select the available amenities. The amenities include safety amenities, such as availability of the first aid kit, smoke alarms, and the like. The next section activities can include various activities that can be performed at the space. For example, a café space can be used for small get together, parties, music lesions, and the like. In the pricing section, the user can specify the availability and price, such as per hour cost of using the space. The cost can be entered for contrasting times of the day, such as cost can be entered for 3-5 pm on Monday, 4-5 pm on Tuesday, and the like. Duration in hours, days, and weeks can be entered, making the disclosed invention versatile and allowing the space to provide to maximum monetization of their spaces. The providers can review their listing anytime and edit the same. FIG. 8 shows a booking confirmation screen 800 which shows the space booked, duration, and payments. FIG. 9 shows distinctive features of the disclosed system.

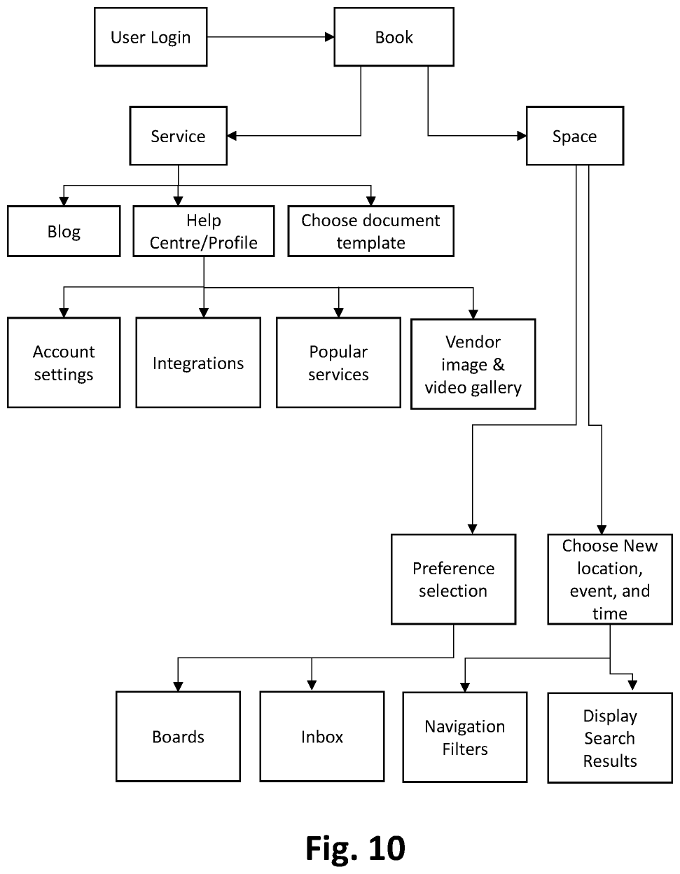

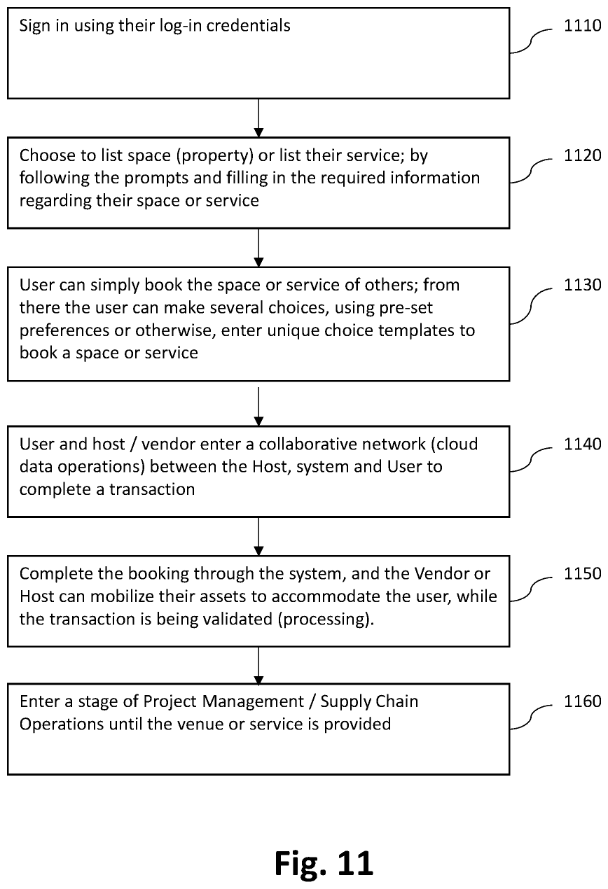

Referring to FIG. 10 which is a block diagram that illustrates the disclosed system and method for booking a space and service. FIG. 11 is a flowchart which illustrates the method for listing the space of service. First, a user logs on or signs up, at step 1110. If the user is already registered, the user can sign in using log-in credentials; if not, the user can create an account, then log in. The user can then choose to list their space (property) or list their service; by following the prompts and filling in the required information regarding their space or service, at step 1120. The user can simply book the space or service of others; from there the user can make several choices, using pre-set preferences or otherwise, enter unique choice templates to book a space or service, at step 1130 The user and host/vendor can enter a collaborative network (cloud data operations) between the Host—Space2market system and user to complete a transaction. For example, if the user chooses a service or space: they will request that the Vendor or Host accept their preferences in accordance with the terms & conditions, and rules of use set forth by the Vendor or Host. If the parties DO NOT agree, the process reverts to the beginning. If the parties agree they will complete the booking through the disclosed platform, and the Vendor or Host will mobilize their assets to accommodate the user, while the transaction is being validated (processing). The User & Host can then enter a stage of Project Management/Supply Chain Operations until the venue or service is provided. Once the transaction is complete, and the user is satisfied with the service or space provided, then close-out documents (Certificate of Completion) will be authenticated by the parties, and the Host will then receive funds for the service or space provided once disclosed platform validates the transaction.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for monetizing utility spaces, the method implemented with a system comprising a processor and a memory, the system configured to implement a method comprising:
providing an interface for a service provider, a space provider, and a user respectively;
receiving, through the interface, from the space provider and the service provider, a listing of a utility space and a listing of a service respectively; and
receiving a link between the service and the utility space.

2. The method according to claim 1, wherein the method further comprises:
generating a space provider profile and a service provider profile, wherein the space provider profile comprises name and contact detail of the space provider, wherein the service provider profile comprises name and contact detail of the service provider.

3. The method according to claim 1, wherein the listing of the utility space comprises details of availability of the utility space in hours for one or more days in a week.

4. The method according to claim 1, wherein the method further comprises:
displaying a list of services for a booked utility space through the interface, wherein the booked utility space is booked by the user, wherein the list of services is linked to the booked utility space.

5. The method according to claim 1, wherein the method further comprises:
displaying a list of utility spaces for a booked service through the interface, wherein the user booked the booked service, wherein the list of utility spaces are linked to the booked service.

6. The method according to claim 1, wherein the method further comprises:
linking a plurality of third-party services to the service and the utility space, wherein the plurality of third-party services comprises customer relationship management services.

7. The method according to claim 1, wherein the utility space is present in a home, garden, lawn, building, office, warehouse, industrial premises, school and college buildings, auditoriums, resorts, laboratories, studios, film sets, or restaurants.

8. The method according to claim 1, wherein the method further comprises:
providing a first listing template to the service provider, a second listing template to the space provider, wherein each of the first listing template and the second listing template are configured to receive information in a structured manner, wherein each of the first listing template and the second listing template are divided into a plurality of sections, the plurality of sections linked to a menu bar.

9. The method according to o claim 8, wherein the second listing template comprises sections for description, location, amenities, photos, pricing, booking, and calendar.

10. A system for monetizing utility spaces, the system comprising a processor and a memory, the system configured to implement a method comprising:
providing an interface for a service provider, a space provider, and a user respectively;
receiving, through the interface, from the space provider and the service provider, a listing of a utility space and a listing of a service respectively; and
receiving a link between the service and the utility space.

11. The system according to claim 10, wherein the method further comprises:
generating a space provider profile and a service provider profile, wherein the space provider profile comprises name and contact detail of the space provider, wherein the service provider profile comprises name and contact detail of the service provider.

12. The system according to claim 10, wherein the listing of the utility space comprises details of availability of the utility space in hours for one or more days in a week.

13. The system according to claim 10, wherein the method further comprises:
displaying a list of services for a booked utility space through the interface, wherein the booked utility space is booked by the user, wherein the list of services is linked to the booked utility space.

14. The system according to claim 10, wherein the method further comprises:
displaying a list of utility spaces for a booked service through the interface, wherein the user booked the booked service, wherein the list of utility spaces are linked to the booked service.

15. The system according to claim 10, wherein the method further comprises:
linking a plurality of third-party services to the service and the utility space, wherein the plurality of third-party services comprises customer relationship management services.

16. The system according to claim 10, wherein the utility space is present in a home, garden, lawn, building, office, warehouse, industrial premises, school and college buildings, auditoriums, resorts, laboratories, studios, film sets, or restaurants.

17. The system according to claim 10, wherein the method further comprises:
providing a first listing template to the service provider, a second listing template to the space provider, wherein each of the first listing template and the second listing template are configured to receive information in a structured manner, wherein each of the first listing template and the second listing template are divided into a plurality of sections, the plurality of sections linked to a menu bar.

18. The system according to o claim 17, wherein the second listing template comprises sections for description, location, amenities, photos, pricing, booking, and calendar.
